(19) United States
(12) Patent Application Publication
(10) Pub. No.: US 2009/0220907 A1
(43) Pub. Date: Sep. 3, 2009

(54) Bracket for Orthodontic

(76) Inventor: Hajime Suyama, Miyazaki (JP)

Correspondence Address: JORDAN AND HAMBURG LLP, 122 EAST 42ND STREET, SUITE 4000, NEW YORK, NY, 10168, US

(21) Appl. No.: 12/226,959

(22) PCT Filed: May 1, 2007
(86) PCT No.: PCT/JP2007/059290

§ 371 Date: Mar. 19, 2009

(30) Foreign Application Priority Data
May 2, 2006 (JP) 2006-128401

(51) Int. Cl. A61C 7/14

(52) U.S. Cl. 433/10

(57) ABSTRACT

A bracket for orthodontic use has a base plate, a tie wing and an arch wire fitting slot. More specifically, a pair of tie wings having a pair of long and short wing pieces, i.e., a long piece and a short piece, are erected on the rectangular base plate and spaced apart, and the arch wire fitting slot is formed by the spaced apart portion. A pair of wing pieces of the tie wing are provided to project in the vertical direction with distal ends directed downward, and constituted the wing pieces include a long piece and a short piece. A recessed guide groove is provided in a vicinity of an end of the long piece.

### BACKGROUND

The present invention relates to a bracket used in orthodontic treatment.

In general, in the first half of orthodontic treatment, because it is necessary to slide an orthodontic bracket along a main wire in order to move teeth, it is better if the resistance between the main wire and the orthodontic bracket is small. On the other hand, in the second half of treatment, because the aligned teeth must be fixed, it is desirable to have large resistance between the main wire and the orthodontic bracket.

Conventional orthodontic brackets comprise a slot for fitting and joining an arch wire or other main wire and a tie wing for catching a ligature wire (or a rubber ring) which fastens and fixes the main wire. In the early stages of treatment (crowded dentition), teeth are moved by the main wire, which is thinner than the width of the slot, using a coil spring and rubber. As the treatment progresses, the main wire is replaced with a thicker one to increase the resistance between the main wire and the orthodontic bracket.

However, these brackets cannot achieve precise control because, in the early stages of treatment, the thin main wire inevitably results in too much play in the slot. In addition, the replacement of the main wire that takes place as treatment progresses causes inconvenience that both the treatment provider (dentist) and the treatment receiver (patient) find complicated and troublesome.

Thus, the present inventor has proposed an orthodontic bracket wherein both ends of a tie wing that are orthogonal to a slot are left with sufficient width for running a ligature wire therealong, engagement claws are provided on both sides of the tie wing that are parallel to the slot, and a widthwise portion just sufficient for running a ligature wire therealong is removed from both ends of the engagement claws. In addition, when the ligature wire is used to prevent an arch wire from becoming dislocated, the use of this orthodontic bracket enables the ligature wire to twist around the bracket without pressing against the arch wire. When teeth are moved mesiodistally, the brackets adhered and fixed to individual teeth can smoothly slide on the arch wire and therefore, friction between the slot and the arch wire can be reduced and a period of orthodontic treatment can be shortened.
[Document 1] JP H5-55142

### SUMMARY OF THE INVENTION

In the above-mentioned configuration wherein engagement claws are provided on both sides of a tie wing, the production process is complicated, the costs pile up, and moreover, it is difficult to make a bracket of a material other than metals, for example, a brittle material such as ceramic.

Therefore, in light of the aforementioned problems of the prior art, the object of the present invention is, of course, to provide an orthodontic bracket which achieves effects similar to those of the prior art, as well to provide an orthodontic bracket for which the resistance between the bracket and the main wire can be easily changed depending on treatment stage, and which can be made easily and inexpensively from a brittle material such as ceramic while ensuring sufficient strength.

The present invention is an orthodontic bracket, comprising a base plate and a pair of tie wings provided along both sides of the base plate and disposed so as to form an arch wire fitting slot therebetween, wherein the tie wings have wing pieces which can engage with a fixture of the arch wire in a cross-stitch-type manner.

The present invention achieves the following advantageous effects.
(1) By switching between two methods for fitting a fixing wire that use a guide groove and the wing pieces of a tie wing, the resistance between arch wire and bracket can easily take two levels, depending on treatment stage. Therefore, the complications that arise by the time the treatment is completed can be reduced significantly compared to conventional orthodontic treatment and the treatment-related burdens on both the treatment provider (dentist) and the treatment receiver (patient) are reduced.
(2) Because it is not necessary to make the wings thin, even with a cosmetic bracket made of a brittle material such as ceramic sufficient strength can be obtained.

### BRIEF DESCRIPTION OF THE DRAWINGS

FIG. 1 is an oblique perspective drawing showing an example of an orthodontic bracket according to the present invention.

FIG. 2 is a plan view showing an orthodontic bracket in FIG. 1.

FIG. 3 is a side view showing an orthodontic bracket in FIG. 1.

FIG. 4 is a plan view showing the first method for fitting a ligature wire.

FIG. 5 is a side view showing the first method for fitting a ligature wire.

FIG. 6 is a plan view showing the second method for fitting a ligature wire.

FIG. 7 is a side view showing the second method for fitting a ligature wire.

### DETAILED DESCRIPTION

An embodiment of the present invention will be explained based on the examples shown in the drawings.

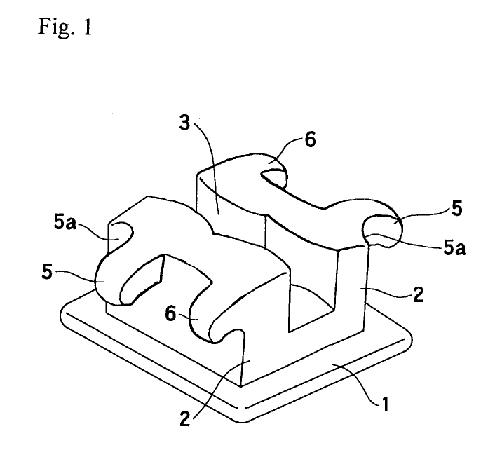

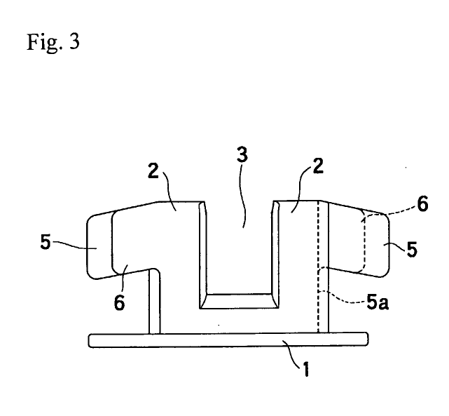

Referring to FIGS. 1 to 3, an orthodontic bracket according to the present invention is integrally made of stainless steel, a synthetic resin, ceramic or the like and comprises primarily a base plate (1), a tie wing (2) and an arch wire fitting slot (3). More specifically, as shown in FIG. 1, the orthodontic bracket is configured such that a pair of tie wings (2) having a pair of long and short wing pieces, that is, a long piece (5) and a short piece (6), are erected on the rectangular base plate (1) spaced apart from each other, and the arch wire fitting slot (3) is formed by this spaced apart portion.

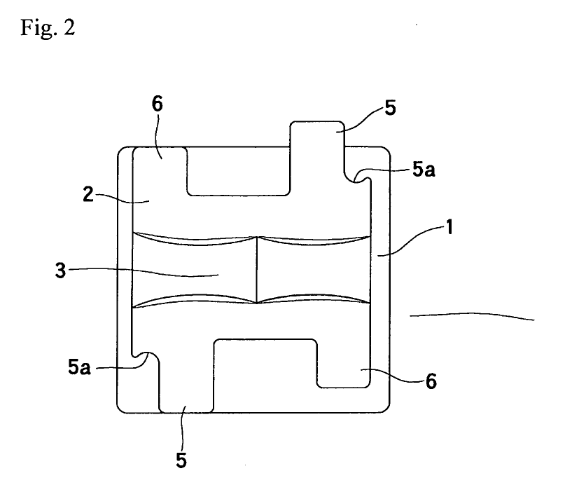

The pair of wing pieces (5, 6) of the tie wing (2) are provided so as to project in the vertical direction, with the distal ends slanting downwardly, and, as shown in FIG. 2, are constituted by the long piece (5) and the short piece (6). A recessed guide groove (5a) is provided at the tie wing (2) portion in the vicinity of the end of one wing piece (long piece) (5).

When orthodontic treatment is carried out using the orthodontic bracket according to the present invention, it is carried out in the following manner.

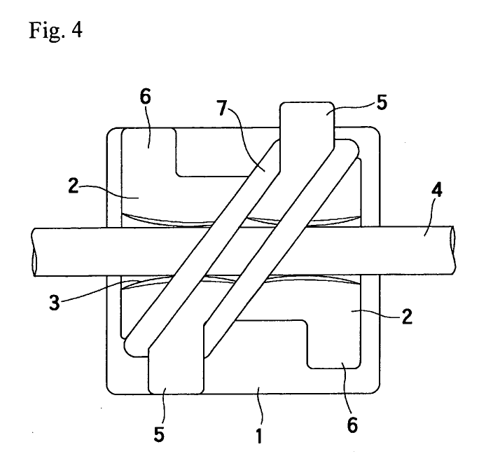

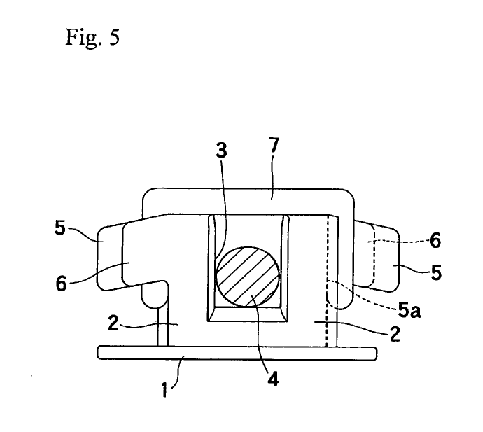

Referring to FIG. 4, in a first half of treatment, during which it is necessary to move teeth, in a state where the orthodontic bracket is bonded to a tooth via the base plate (1), an arch wire (main wire) (4) having substantially the same diameter as the width of the arch wire fitting slot (3) of the orthodontic bracket is fitted to the slot (3). Then, as shown in FIG. 4 and FIG. 5, a ligature wire (fixture) (7) is placed on the orthodontic bracket by being hitched to the wing pieces (long pieces) (5) of the tie wings (2) via the guide grooves (5a) in such a manner that the ligature wire (7) is diagonal to the tie wings (2), in other words, in a cross-stitch-type manner. Thus, as shown in FIG. 5, because the ligature wire (7) does not directly contact the arch wire (4), the orthodontic bracket can slide along the arch wire (4) without resistance. In this case, because the arch wire (4) has substantially the same diameter as the width of the slot (3) and there is little play in the slot (3), precise control can be achieved. In addition, as shown in FIG. 5, the ligature wire (7) is fitted so as to cover the opening of the slot (3) and therefore, the arch wire (4) does not come free from the slot (3).

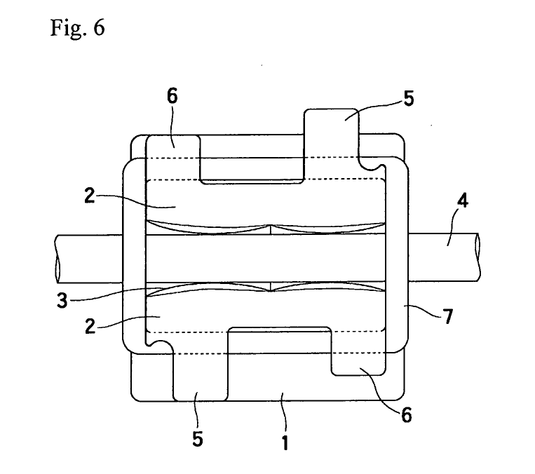

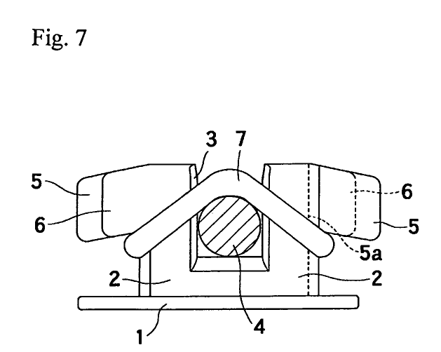

In the second half of treatment, in which it is necessary to fix the aligned teeth in place, the aforementioned ligature wire (7) is detached and then, as shown in FIG. 6 and FIG. 7, another ligature wire (7) is placed on the orthodontic bracket by being hitched to the tie wings (2) via all the pair of wing pieces (5, 6) of the tie wings (2) in such a manner that the ligature wire (7) forms a rectangle. Thus, as shown in FIG. 7, the ligature wire (7) strongly fixes the arch wire in place (4) by pressing it against the base plate (1) of the orthodontic bracket; this is effective in cases where some teeth are pulled into place while other teeth are being fixed in place. In this case, because the afore-mentioned arch wire (4) can be effectively used as is, it is not necessary to replace the arch wire (4).

As discussed above, simply by switching between the two methods for fitting the ligature wire (7), the resistance between the arch wire (4) and the bracket can easily take two levels and the complications that arise by the time the treatment is completed can be reduced significantly.

In addition, in the above embodiment, an explanation was made of the case where the ligature wire (7) is used as a fixture to fix the arch wire (4) to the tie wings (2), but it goes without saying that the orthodontic treatment can also be provided using a rubber ring in place of the ligature wire (7).

1. An orthodontic bracket, comprising:
a base plate having opposing first and second side edges a bottom surface for attachment to a tooth, and a top surface;
first and second wing support members provided extending from said top surface and respectively having first sides which are positioned apart from and opposing each other to define an arch wire groove therebetween and top support member edges running along said arch wire groove, said wing support members having opposing support member first ends defining a first end of said arch wire groove therebetween, said wing support members having opposing support member second ends defining a second end of said arch wire groove therebetween, said tie wing support members being disposed respectively adjacent along said first and second side edges of the base plate; and
the wing support members each respectively having second sides opposite said first sides thereof, said second sides each having first and second wing prongs extending outward therefrom and curving toward said base plate and configured to engage with a fixing wire of the arch wire in a cross-stitch-type manner, said first wing prongs being longer than said second wing prongs.

2. The orthodontic bracket according to claim 1, wherein:
said first wing support member has said first wing prong member disposed offset from said support member first end of said first wing support member; and
said second wing support member has said first wing prong member disposed offset from said support member second end of said second wing support member such that said first wing prong members are disposed proximate diagonally opposed corners of said base plate.

3. The orthodontic bracket according to claim 2, wherein:
said first wing support member has said second wing prong member disposed even with said support member second end of said first wing support member; and
said second wing support member has said second wing prong member even with said support member first end of said second wing support member such that said second wing prong members are disposed proximate diagonally opposed corners of said base plate.

4. The orthodontic bracket according to claim 3, wherein:
said first wing support member has a concaved surface portion between said first wing prong member and said support member first end of said first wing support member, said concaved surface portion being configured to engage said fixing wire; and
said second wing support member has a concaved surface portion between said first wing prong member and said support member second end of said second wing support member, said concaved surface portion being configured to engage said fixing wire.

5. The orthodontic bracket according to claim 4, further comprising:
said fixing wire, said fixing wire being formed in a continuous loop with opposing ends respectively hooked under said first wing prong members and portions of said fixing wire being disposed in said concaved surface portions;
said fixing wire extending over said top support member edges at four places so as to leave said groove ends unopposed by said fixing wire; and
said fixing wire being disposed to extend diagonally between said first wing prong members without engagement with said second wing prong members.

6. The orthodontic bracket according to claim 2, wherein:
said first wing support member has a concaved surface portion between said first wing prong member and said support member first end of said first wing support member, said concaved surface portion being configured to engage said fixing wire; and
said second wing support member has a concaved surface portion between said first wing prong member and said support member second end of said second wing support member, said concaved surface portion being configured to engage said fixing wire.

7. The orthodontic bracket according to claim 6, further comprising:
said fixing wire, said fixing wire being formed in a continuous loop with opposing ends respectively hooked under said first wing prong members and portions of said fixing wire being disposed in said concaved surface portions;
said fixing wire extending over said top support member edges at four places so as to leave said groove ends unopposed by said fixing wire; and
said fixing wire being disposed to extend diagonally between said first wing prong members without engagement with said second wing prong members.
